(19) United States
(12) Patent Application Publication
(10) Pub. No.: US 2021/0291556 A1
(43) Pub. Date: Sep. 23, 2021

(54) THERMAL SENSING DEVICE HAVING CLEANING FUNCTION AND METHOD FOR USING THE SAME

(71) Applicant: CHIEN HWA COATING TECHNOLOGY, INC., HSINCHU CITY (TW)

(72) Inventors: YULUNG TSAO, HSINCHU CITY (TW); YIWEI LIN, HSINCHU CITY (TW); CHUNCHEN CHEN, HSINCHU CITY (TW)

(21) Appl. No.: 16/884,112

(22) Filed: May 27, 2020

(30) Foreign Application Priority Data
Mar. 20, 2020 (TW) 109109521

(51) Int. Cl. B41J 2/355; B41J 2/375

(52) U.S. Cl. CPC B41J 2/3553; B41J 2/375

(57) ABSTRACT

The present invention provides a thermal sensing device having cleaning function and the method for using the same. The thermal sensing device comprises a top lid and a bottom lid. The top lid includes a thermal sensing member; the bottom lid includes a paper roller correspondingly. When the top lid covers the bottom lid, the paper roller contacts the thermal sensing member. To clean, take out the paper roller, dispose a cleaning roller inside the bottom lid, and cover the top lid to the bottom lid so that the thermal sensing member contacts the cleaning roller. Drive a motor in the bottom lid to rotate the cleaning roller. Since the cleaning roller includes an antistatic glue layer, the cleaning roller will adhere to one or more object on the thermal sensing member via the antistatic glue layer.

### FIELD OF THE INVENTION

The present invention relates generally to a device and a method, and particularly to a thermal sensing device having cleaning function and the method for using the same.

### BACKGROUND OF THE INVENTION

As technologies and commerce develop, invoices and receipts are required while paying a bill. Hence, a printer is included in a cashier. In particular, a heat sensitive printer (or a thermal printer) is widely adopted in retail, catering, and transportation businesses for printing receipts, price tags, or transportation details. As the applications of printers being extended, the type of printing media also varies with the user's application. Among the hest sensitive printers, the one of smaller structure is mostly applied, and the thermal paper (or called heat sensitive paper) is used therein.

The thermal paper adopts a chemical material coated thereon so that the color of the paper can be changed after being heated and need not use ink in the process. The thermal paper can be used in a thermal printer disposed in a lightweight and small-sized device such as a fax machine, an addometer, a cashier, and a credit-card terminal for reducing the cost.

The surface of the thermal paper is coated with solid dye and appropriate substrate, such as fluorane-type invisible dye and octadecylphosphonic acid. When the substrate is heated to the melting point, the dye will react with the acid material and transform into the colored state. As the substrate being cooled down quickly, the colored state of the dye will retain in a metastable state. After a period, the color still will fade. Thereby, the thermal paper is only suitable for applications not requiring long-term storage.

Due to the high frequency of printing, the thermal print head (TPH) in a thermal sensing device wear soon. The damages caused by dust, wear, or cleaning shorten the lifetime the a TPH. Thereby, how to clean rapidly and extends the lifetime of TPH is the present and urgent issue.

The current method for cleaning a TPH is to use a cleaning pen or cleaning paper. The most common method is to use a cotton swab or soft cloth wet by alcohol to wipe the TPH and roller. Unfortunately, owing to the way a user wipes or the material of the cleaning cloth or cotton swab, electrification of static electricity by friction tends to occur.

For most cases of adopting the current method of cleaning a TPH, the static electricity generated in the wiping process will damage the TPH due to the wiping technique or the material of the cleaning cloth.

Alternatively, according to another method, after the TPH is heated, the dust will attach to the thermal paper of a thermal printer for removal. Nonetheless, this method will increase heat up a thermal printer to a high temperature and affect the lifetime of the TPH. In addition, additional usage of thermal paper also leads to waste.

Accordingly, the present invention provides an anti-static-charge cleaning guiding wheel capable of performing automatic cleaning, preventing electrostatic penetration, and improving the lifetime of TPH. Above the roller, anti-electrostatic silica gel is adopted for preventing electrostatic penetration due to wiping. In addition, silica-gel roller owns exceptional dust-collecting performance, as well as ease of cleaning and wiping and durability. By collecting dust and cleaning using a silica-gel roller to contact a TPH directly, damages on the TPH due to static charges and personal cleaning techniques can be avoided.

According to the above description, the present invention provides a thermal sensing device having cleaning function and the cleaning method thereof. According to the present invention, a silica-gel roller is adopted to adhere to the dirt on a TPH. Since a silica-get roller can adhere to dirt automatically without inducing static charges, manual cleaning of a TPH that might damage the TPH due to induced static charges in the TPH or scratches is not required. Thereby, the lifetime of a TPH can extended.

### SUMMARY

An objective of the present invention is to provide a method for using a thermal sensing device having cleaning function. A roller can adhere to the dirt on the thermal sensing member without inducing static charges. Thereby, damages on the thermal sensing device caused by static charges can be avoided.

Another objective of the present invention is to provide a thermal sensing device having cleaning function. The original paper roller in the machine is replaced by a cleaning roller. Cleaning can be performed right after printing. Maintenance is required for the roller only. Thereby, the cleaning process can be simplified.

A further objective of the present invention is to provide a thermal sensing device having cleaning function. By replacing the paper roller by a cleaning roller and cleaning the thermal sensing member directly, no disassembling and assembling of the device is required. Thereby, damages caused by manual replacement can be reduced.

To achieve one of the above objectives, the present invention provides a method for using a thermal sensing device having cleaning function. A thermal sensing device comprises a top lid and a bottom lid. The top lid includes a thermal sensing member; the bottom lid includes a paper roller correspondingly. When the top lid covers the bottom lid, the paper roller contacts the thermal sensing member. To clean, take out the paper roller and follow the following steps: disposing a cleaning roller inside the bottom lid, where the cleaning roller includes an antistatic glue layer; when the top lid covers the bottom lid, contacting the thermal sensing member in the top lid to the cleaning roller; driving a motor in the bottom lid to spin the cleaning roller; and the antistatic glue layer adhering to one or more object on the thermal sensing member.

According to an embodiment of the present invention, after the step of the antistatic glue layer adhering to one or more object on the thermal sensing member, take out the cleaning roller to perform a cleaning process.

According to an embodiment of the present invention, the antistatic glue layer is anti-electrostatic silica gel.

According to an embodiment of the present invention, the material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent.

To achieve one of the above objectives, the present invention provides a thermal sensing device having cleaning function, which comprises a top lid and a bottom lid. The top lid includes a thermal sensing member; the bottom lid includes a paper roller correspondingly. When the top lid covers the bottom lid, the paper roller contacts the thermal sensing member. To clean, take out the paper roller. The thermal sensing device having cleaning function comprises a cleaning roller and a motor. The cleaning roller includes a cleaning wheel and an antistatic glue layer. The motor is disposed on one side of the cleaning roller. An axis of the motor inserts into the cleaning roller. To clean the thermal sensing device, after placing the cleaning roller and covering the top lid to the bottom lid, the thermal sensing member contacts the cleaning roller. Then drive the motor to spin the cleaning roller, and enabling the antistatic glue layer to adhere to one or more object on the thermal sensing member.

According to an embodiment of the present invention, the antistatic glue layer is anti-electrostatic silica gel.

According to an embodiment of the present invention, the material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent.

To achieve one of the above objectives, the present invention provides a thermal sensing device having cleaning function, which comprises a top lid, a bottom lid, a rotating base, and a motor. A thermal sensing member is disposed inside the top lid. The bottom lid includes a casing. One side of the casing is pivoted on one side of the top lid. A rotating motor is disposed inside the casing. The rotating base is disposed on a motor axis of the rotating motor. The rotating base includes a paper roller and a cleaning roller on one side. The cleaning roller includes a cleaning wheel covered by an antistatic glue layer. The motor is disposed on one side of the rotating motor and includes a driving gear gearing into a first gear on one side of the paper roller or a second gear of the cleaning roller. The motor spins the paper roller or the cleaning roller. To clean the thermal sensing device, the rotating motor is driven to rotate, driving the rotating base to rotate. Then the locations of the paper roller and the cleaning roller will be switched. When the thermal sensing member contacts the cleaning roller, the motor is driven to spin the cleaning roller. Thereby, the antistatic glue layer can adhere to one or more object on the thermal sensing member.

According to an embodiment of the present invention, the antistatic glue layer is anti-electrostatic silica gel.

According to an embodiment of the present invention, the material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent.

### BRIEF DESCRIPTION OF THE DRAWINGS

FIG. 1 shows a flowchart of the usage method according to the first embodiment of the present invention;

FIG. 2A shows a schematic diagram of the structure according to the first embodiment of the present invention;

FIG. 2B shows a schematic diagram of replacing roller according to the first embodiment of the present invention;

FIG. 2C shows a schematic diagram of the usage state according to the first embodiment of the present invention;

FIG. 3A shows a schematic diagram of the structure according to the second embodiment of the present invention;

FIG. 3B shows a schematic diagram of replacing roller according to the second embodiment of the present invention; and

FIG. 3C shows a schematic diagram of the usage state according to the second embodiment of the present invention.

### DETAILED DESCRIPTION

While cleaning a TPH using the method according to the prior art, a cleaning cloth is normally adopted for direct wiping. In the wiping process, static charges will be induced and shortening the lifetime of the TPH. In addition, different wiping techniques might damage the TPH as well.

The present invention improves the method for cleaning a TPH. An improved roller replaces the paper roller according to the prior art. The improved roller owns the characteristics of anti-electrostatic induction and reduced dirt adhesion. By cleaning the dirt on a thermal sensing member directly, damages on the TPH owing to electrostatic penetration will not occur.

In the following description, various embodiments of the present invention are described using figures for describing the present invention in details. Nonetheless, the concepts of the present invention can be embodied by various forms. Those embodiments are not used to limit the scope and range of the present invention.

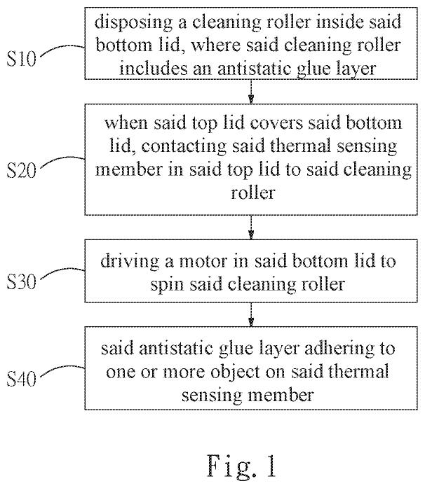

First, please refer to FIG. 1, which shows a flowchart of the usage method according to the first embodiment of the present invention. As shown in the figure, the method comprises steps of:
Step S10: Disposing the cleaning roller inside the bottom lid, where the cleaning roller includes the antistatic glue layer;
Step S20: When the top lid covers the bottom lid, the thermal sensing member inside the top lid contacting the cleaning roller;
Step S30: Driving the motor inside the bottom lid to spin the cleaning roller; and
Step S40: Using the antistatic glue layer to adhere to the object on the thermal sensing member.

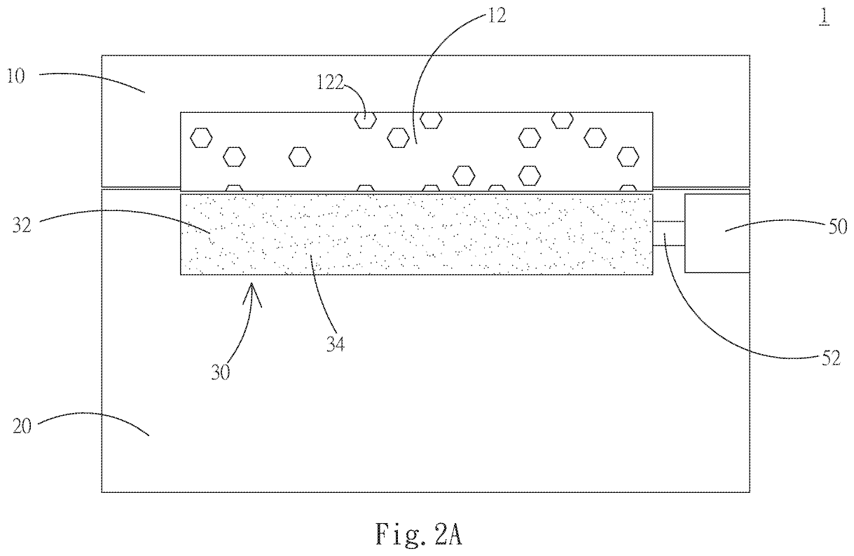

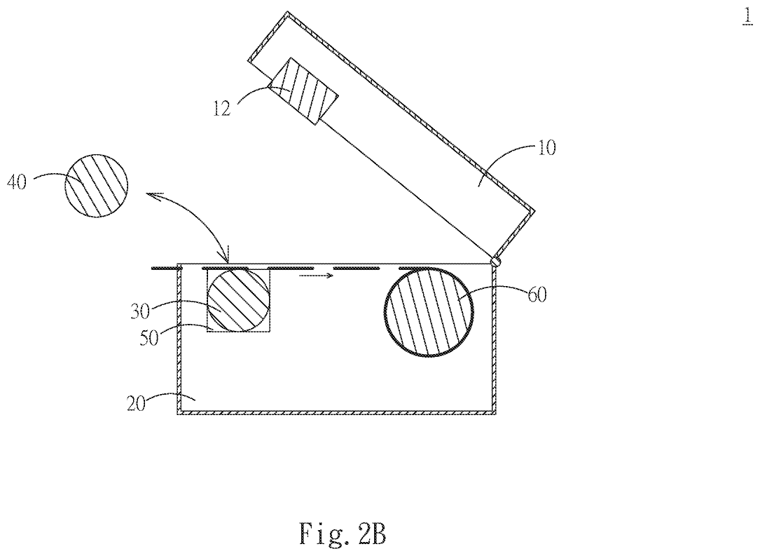

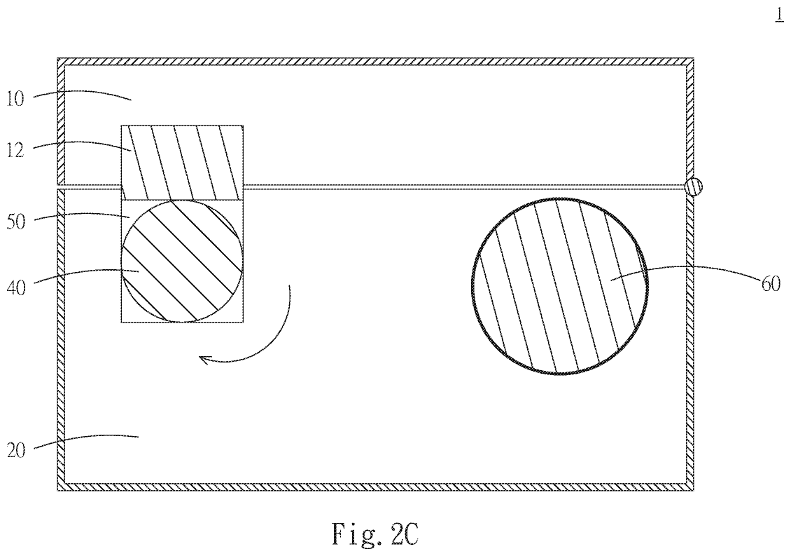

Please refer to FIG. 2A, which shows a schematic diagram of the structure according to the first embodiment of the present invention. As shown in the figure, the first embodiment according to the present invention is applied to a thermal sensing device 1, which comprises a top lid 10 and a bottom lid 20.

The top lid 10 includes a thermal sensing member 12; the bottom lid 20 includes a paper roller 40 correspondingly. When the top lid 10 covers the bottom lid 20, the paper roller 40 contacts the thermal sensing member 12. To clean, take out the paper roller 40 and follow the steps S10 to S40: after retrieving the paper roller 30, disposing a cleaning roller 30 inside the bottom lid 20; when the top lid 10 covers the bottom lid 20, contacting the cleaning roller 30 to the thermal sensing member 12; driving a motor 50 in the bottom lid 20 to spin the cleaning roller 30; and since the cleaning roller 30 including an antistatic glue layer 34, the antistatic glue layer 34 adhering to one or more object 122 on the thermal sensing member 12.

Next, after the step of the antistatic glue layer 34 adhering to one or more object 122 on the thermal sensing member 12, the usage method according to the present invention further comprises a step of:
Step S50: Retrieving the cleaning roller and place the paper roller back for completing the cleaning process.

After the step of the antistatic glue layer 34 adhering to one or more object 122 on the thermal sensing member 12, once the antistatic glue layer 34 adheres to plenty of the one or more object 122, open the top lid 10 to take out the cleaning roller 30. The one or more object 122 on the cleaning roller 30 can be removed by water or a cleaning plate. After cleaning, the cleaning roller 30 can be stored before next repeated cleaning of the thermal sensing device 1.

In addition, according to the first embodiment of the present invention, the cleaning roller 30 can replace the paper roller 40 according to the prior art for preventing multiple operations of disassembling and assembling.

Moreover, the antistatic glue layer 34 according to the first embodiment of the present invention is anti-electrostatic silicone gel. The material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent. Normally, reinforcing stuffing adopts acetylene carbon black, conductive furnace black, or conductive channel black with superior conductivity and anti-electrostatic capability. Weak reinforcing stuffing adopts the mixture of siliceous earth, titanium oxide, and quartz flour. The raw materials come from minerals with low cost and extensive applications. By using vinyl silicone rubber as the major raw material, the tensile strength and the tearing strength of the fabricated silicone gel are enhanced. The additive adopts the mixture of polyvinyl alcohol coating liquid and hardening liquid. The wear resistance can be improved and hence extending the lifetime of products and suitable for extensive applications.

Next, please refer to FIG. 2A, as shown in the figure, the thermal sensing device 1 comprises the top lid 10, the thermal sensing member 12, the one or more object 12, the bottom lid 20, the cleaning roller 30, the cleaning wheel 32, the antistatic glue layer 34, the motor 50, and an axis 52.

Next, please refer to FIG. 2B, which shows a schematic diagram of replacing roller according to the first embodiment of the present invention. As shown in the figure, the thermal sensing device 1 comprises the top lid 10 and the bottom lid 20. The top lid 10 includes the thermal sensing member 12; the bottom lid 20 includes a paper roller 40 correspondingly. When the top lid 10 covers the bottom lid 20, the paper roller 40 contacts the thermal sensing member 12. To clean, take out the paper roller 40 and dispose the cleaning roller 30. When the top lid 10 covers the bottom lid 20, the thermal sensing member 12 contacts the cleaning roller 30. The cleaning roller 30 includes the cleaning wheel 32 and the antistatic glue layer 34. The axis 52 of the motor 50 is inserted into the cleaning roller 30. Thereby, drive the motor 50 to spin the cleaning roller 30 and enabling the antistatic glue layer 34 to adhere to the one or more object 122 on the thermal sensing member 12.

The antistatic glue layer 34 according to the first embodiment of the present invention is anti-electrostatic silicone gel. The material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent. Normally, reinforcing stuffing adopts acetylene carbon black, conductive furnace black, or conductive channel black with superior conductivity and anti-electrostatic capability. Weak reinforcing stuffing adopts the mixture of siliceous earth, titanium oxide, and quartz flour. The raw materials come from minerals with low cost and extensive applications. By using vinyl silicone rubber as the major raw material, the tensile strength and the tearing strength of the fabricated silicone gel are enhanced. The additive adopts the mixture of polyvinyl alcohol coating liquid and hardening liquid. The wear resistance can be improved and hence extending the lifetime of products and suitable for extensive applications.

Next, to explain the first embodiment of the present invention, a practical example is taken for description. Please refer to FIG. 2C, which shows a schematic diagram of the usage state according to the first embodiment of the present invention. As shown in the figure, after multiple prints, the printed patterns by the thermal sensing device 1 appear multiple irregular shapes. At this moment, the users A judges that dirt appear on the thermal sensing member 12. Thereby, the thermal sensing device 1 controls a sensing paper roll 60 to roll back into the machine. Open the top lid 10 of the thermal sensing device 1 and take out the paper roller 40 in the bottom lid 20 before placing the cleaning roller 30. Next, the thermal sensing device 30 controls the motor 50 to spin for driving the cleaning roller 30 to spin. The antistatic glue layer 34 on the cleaning roller 30 adheres to the dirt (the one or more object 122) on the thermal sensing member 12. After completion, the cleaning roller 30 can be cleaned and stored before next cleaning.

The cleaning method according to the present invention is different from the method of directly wiping the thermal sensing member according to the prior art. In the method according to the prior art, static charges will be induced by multiple back-and-forth wipes. The static charges will penetrate the thermal sensing member 12 and result in damages. Besides, owing to different cleaning techniques, multiple cleanings and consequently linger time might be required. On the contrary, according to the present invention, direct replacement of the cleaning roller is adopted. The machine controls the cleaning for the thermal sensing member 12 and hence saving the time. Besides, the antistatic glue layer 34 on the cleaning roller 30 can prevent static-charge induction. The glue also owns superior dust-collecting performance as well as ease of cleaning for repeated usage. Thereby, damages on the thermal sensing member 12 due to static charges can be prevented and consumables for cleaning can be reduced.

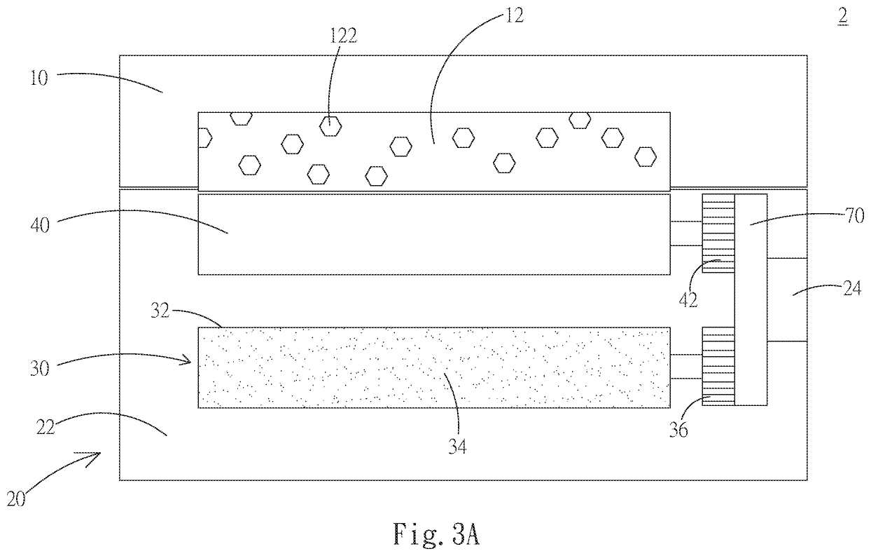

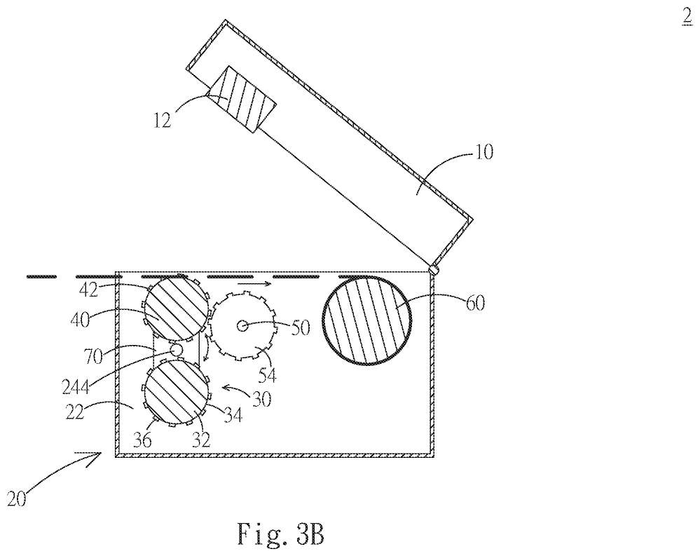

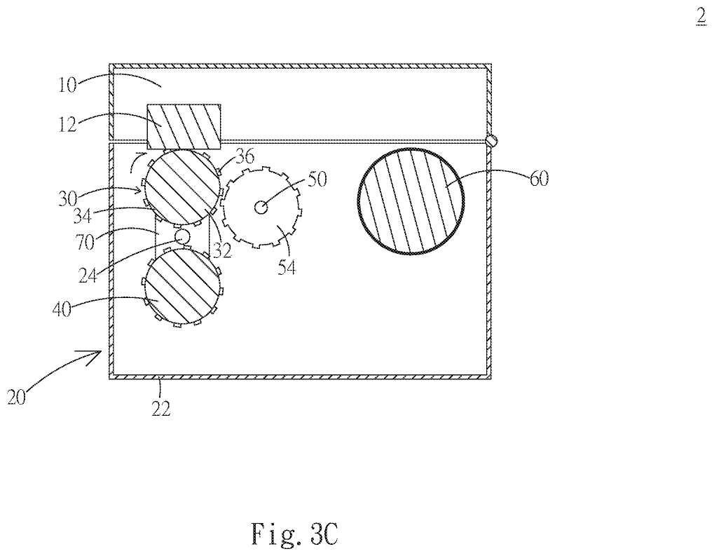

Next, please refer to FIG. 3A, which shows a schematic diagram of the structure according to the second embodiment of the present invention. As shown in the figure, a thermal sensing device 2 comprises a top lid 10, a thermal sensing member 12, one or more object 122, a bottom lid 20, a casing 22, a rotating motor 24, a cleaning roller 30, a cleaning wheel 32, an antistatic glue layer 34, a second gear 36, a paper roller 40, a first gear 42, and a rotating base 70.

Next, please refer to FIG. 3B, which shows a schematic diagram of replacing roller according to the second embodiment of the present invention. As shown in the figure, the thermal sensing device 2 according to the second embodiment of the present invention comprises the top lid 10 and the bottom lid 20. The thermal sensing member 12 is disposed inside the top lid 10. The bottom lid includes a casing 22. One side of the casing 22 is pivoted on one side of the top lid 10. The rotating motor 24 is disposed inside the casing 22. The rotating base 70 is disposed on a motor axis 244 of the rotating motor 24. The rotating base 70 includes a paper roller 40 and a cleaning roller 30 on one side. The cleaning roller 30 includes a cleaning wheel 32 covered by an antistatic glue layer 34. To clean the thermal sensing device 2, the rotating motor 24 is driven to rotate, driving the rotating base 70 to rotate. Then the locations of the paper roller 40 and the cleaning roller 30 will be switched. When the top lid 10 covers the bottom lid 20, the thermal sensing member 12 contacts the cleaning roller 30, and the motor 50 disposed on one side of the rotating motor 24 is driven to spin the cleaning roller 30. Thereby, the antistatic glue layer 34 can adhere to one or more object 122 on the thermal sensing member 12.

The motor 50 includes a driving gear 54 gearing into a first gear 42 on one side of the paper roller 40 or a second gear 36 of the cleaning roller 30. Furthermore, the motor 50 spins the paper roller 40or the cleaning roller 30. Thereby, the thermal sensing device 2 can perform the thermal-sensing printing procedure or the cleaning process for the thermal sensing member 12.

The antistatic glue layer 34 according to the present invention is anti-electrostatic silicone gel. The material of the anti-electrostatic silica gel is selected from the group consisting of silicone rubber, vinyl silicone rubber, stearic acid, fluorosilicon rubber, vulcanizing agent, reinforcing stuffing, weak reinforcing stuffing, additive, and coloring agent. Normally, reinforcing stuffing adopts acetylene carbon black, conductive furnace black, or conductive channel black with superior conductivity and anti-electrostatic capability. Weak reinforcing stuffing adopts the mixture of siliceous earth, titanium oxide, and quartz flour. The raw materials come from minerals with low cost and extensive applications. By using vinyl silicone rubber as the major raw material, the tensile strength and the tearing strength of the fabricated silicone gel are enhanced. The additive adopts the mixture of polyvinyl alcohol coating liquid and hardening liquid. The wear resistance can be improved and hence extending the lifetime of products and suitable for extensive applications.

Next, to explain the second embodiment of the present invention, a practical example is taken for description. Please refer to FIG. 3C, which shows a schematic diagram of the usage state according to the second embodiment of the present invention. As shown in the figure, after multiple prints, the printed patterns by the thermal sensing device 2 appear multiple irregular shapes. At this moment, the users B judges that dirt appear on the thermal sensing member 12. Thereby, after the thermal sensing device 2 controls a sensing paper roll 60 to roll back into the machine, a roller switching procedure in the thermal sensing device 2 is started. The rotating motor 24 is controlled to switch the locations of the paper roller 40 and the cleaning roller 30 in the thermal sensing device 2. At this time, the thermal sensing member 12 will contact the cleaning roller 30 directly. Then the thermal sensing device 2 is started to operate again for controlling the motor 50 to spin and hence driving the cleaning roller 30 to spin. The antistatic glue layer 34 on the cleaning roller 30 is used to adhere to the dirt (namely, the one or more object 122) on the thermal sensing member 12. After cleaning, the roller switching procedure is executed again for switching the locations of the cleaning roller 30 and the paper roller 40. Then the thermal sensing procedure can go on. In the future, once the cleaning roller 30 reaches a certain dirty level, the cleaning roller 30 in the thermal sensing device 2 is take out for cleaning and wiping.

The cleaning method according to the second embodiment of the present invention is different from the method of directly wiping the thermal sensing member 12 according to the prior art. In the method according to the prior art, static charges will be induced by multiple back-and-forth wipes. The static charges will penetrate the thermal sensing member 12 and result in damages. Besides, owing to different cleaning techniques, multiple cleanings and consequently linger time might be required. On the contrary, according to the present invention, direct replacement of the cleaning roller is adopted. The machine controls the cleaning for the thermal sensing member 12 and hence saving the time. Besides, the antistatic glue layer 34 on the cleaning roller 30 can prevent static-charge induction. The glue also owns superior dust-collecting performance as well as ease of cleaning for repeated usage. Thereby, damages on the thermal sensing member 12 due to static charges can be prevented and consumables for cleaning can be reduced.

According to the above embodiments, the present invention provides a thermal sensing device having cleaning function and the method for using the same. By using the cleaning roller with the antistatic glue layer to adhere to dirt, static charges that can damage the thermal sensing member during the cleaning process can be prevented. In addition, the cleaning roller is reusable. Thereby, cleaning consumables can be reduced.

What is claimed is:

1. A method for using a thermal sensing device having cleaning function; said thermal sensing device comprises a top lid and a bottom lid, a thermal sensing member is disposed in said top lid, and a paper roller is disposed in said bottom lid correspondingly; when said top lid covers said bottom lid, said paper roller contacts said thermal sensing member; when cleaning, take out said paper roller and follow the steps below:
disposing a cleaning roller inside said bottom lid, where said cleaning roller includes an antistatic glue layer;
when said top lid covers said bottom lid, contacting said thermal sensing member in said top lid to said cleaning roller;
driving a motor in said bottom lid to spin said cleaning roller; and
said antistatic glue layer adhering to one or more object on said thermal sensing member.

2. The method for using a thermal sensing device having cleaning function of claim 1, wherein said step of said antistatic glue layer adhering to one or more object on said thermal sensing member further comprises a step of retrieving said cleaning roller for performing a cleaning process.

3. The method for using a thermal sensing device having cleaning function of claim 1, wherein said antistatic glue layer is an anti-electrostatic silicone gel.

4. The method for using a thermal sensing device having cleaning function of claim 1, wherein said antistatic glue layer is selected from the group consisting of silicone rubber, vinyl silicone rubber, stearic acid, fluorosilicon rubber, vulcanizing agent, reinforcing stuffing, weak reinforcing stuffing, additive, and coloring agent.

5. A thermal sensing device having cleaning function, said thermal sensing device comprises a top lid and a bottom lid, a thermal sensing member is disposed in said top lid, and a paper roller is disposed in said bottom lid correspondingly; when said top lid covers said bottom lid, said paper roller contacts said thermal sensing member; when cleaning, take out said paper roller; and comprising:
a cleaning roller, disposed inside said top lid, including a cleaning wheel, and an antistatic glue layer covering said cleaning wheel; and
a motor, disposed on one side of said cleaning roller, and an axis of said motor inserting into said cleaning roller;
where to clean said thermal sensing device, after placing said cleaning roller and covering said top lid to said bottom lid, said thermal sensing member contacts said cleaning roller; then drive said motor to spin said cleaning roller, and enabling said antistatic glue layer to adhere to one or more object on said thermal sensing member.

6. The thermal sensing device having cleaning function of claim 5, wherein said antistatic glue layer is an anti-electrostatic silicone gel.

7. The thermal sensing device having cleaning function of claim 5, wherein said antistatic glue layer is selected from the group consisting of silicone rubber, vinyl silicone rubber, stearic acid, fluorosilicon rubber, vulcanizing agent, reinforcing stuffing, weak reinforcing stuffing, additive, and coloring agent.

8. A thermal sensing device having cleaning function, comprising:
a top lid, including a thermal sensing member therein;
a bottom lid, including a casing, one side of said casing pivoted on one side of said top lid, and a rotating motor disposed inside said casing;
a rotating base, disposed on a motor axis of said rotating motor, including a paper roller and a cleaning roller on one side, said cleaning roller including a cleaning wheel covered by an antistatic glue layer; and
a motor, disposed on one side of said rotating motor, including a driving gear gearing into a first gear on one side of said paper roller or a second gear of the cleaning roller; and said motor rotates said paper roller or said cleaning roller;
where to clean said thermal sensing device, said rotating motor is driven to rotate, driving said rotating base to rotate; then the locations of said paper roller and said cleaning roller will be switched; when said thermal sensing member contacts said cleaning roller, said motor is driven to spin said cleaning roller, enabling said antistatic glue layer to adhere to one or more object on said thermal sensing member.

9. The thermal sensing device having cleaning function of claim 8, wherein said antistatic glue layer is an anti-electrostatic silicone gel.

10. The thermal sensing device having cleaning function of claim 8, wherein said antistatic glue layer is selected from the group consisting of silicone rubber, vinyl silicone rubber, stearic acid, fluorosilicon rubber, vulcanizing agent, reinforcing stuffing, weak reinforcing stuffing, additive, and coloring agent.
